(19) United States
(12) Patent Application Publication
(10) Pub. No.: US 2025/0299010 A1
(43) Pub. Date: Sep. 25, 2025

(54) METHOD AND APPARATUS FOR TRACKING PALLETS

(71) Applicant: Engineered Products of Ohio, LLC, Cortland, OH (US)

(72) Inventors: Brian Keith BLANK, Cortland, OH (US); Justine BLANK, Cortland, OH (US)

(73) Assignee: Engineered Products of Ohio, LLC, Cortland, OH (US)

(21) Appl. No.: 19/086,570

(22) Filed: Mar. 21, 2025

Related U.S. Application Data
(60) Provisional application No. 63/568,687, filed on Mar. 22, 2024.

(51) Int. Cl. G06K 19/07; B65D 19/38

(52) U.S. Cl. CPC G06K 19/0723; B65D 19/38; B65D 2519/00736

(57) ABSTRACT

A tracking apparatus for tracking pallets and other shipping units. The tracking apparatus includes a main body that has a first end, a second end opposite to the first end, and a longitudinal axis defined therebetween. The tracking apparatus also defines a cavity that extends downwardly into the main body along an axis that is non-parallel to the longitudinal axis. The tracking apparatus also includes a tracking element that is encapsulated inside of the cavity and is free from being in contact with an external environment that is external to the main body. The main body of the tracking apparatus also is adapted to be mounted to a shipping unit

### REFERENCE TO RELATED APPLICATIONS

This application claims the benefit of U.S. Provisional Application Ser. No. 63/568,687, filed on Mar. 22, 2024; the disclosure of which is incorporated herein by reference.

### TECHNICAL FIELD

This disclosure is directed to a robust tracking apparatus that is attached to a pallet or similar shipping unit for logistic operations.

### BACKGROUND ART

In logistic operations, apparatuses and/or mechanisms for tracking pallets, shipping containers, and other shipping units in real time are crucial for various types of businesses and industries. In one instance, such apparatuses are beneficial for tracking the location and status of cargo or material loaded inside a user's warehouse, depot, or storage facility in real time. In another instance, such apparatuses are beneficial for tracking the location and status of cargo or material loaded in transit between the user's storage facility and a recipient's or receiving user's storage facility in real time.

Normally, these apparatuses include or are equipped with one or more machine-readable identifiers that are attached to pallets, shipping containers, and other shipping units supporting such cargo or material for tracking in real time. In one instance, however, such machine-readable identifiers are simply attached to pallets, shipping containers, and other shipping units with adhesives or similar bonding components that are adhered to the outer surface of said pallets, shipping containers, and other shipping units. With such arrangement, these machine-readable identifiers are constantly in communication with the surrounding environment and elements when transported between various locations. As such, it is probable that these machine-readable identifiers may deteriorate or become destroyed due to the constant interaction with the external environment and elements when transported between various locations, including machines that handle these pallets, shipping containers, and other shipping units, weather conditions, and other various external environment and elements. In another instance, such these apparatuses may only be configurable with a single machine-readable identifier technology. Such configuration is limiting and may restrict such use of these apparatuses or mechanisms when certain logistic operations required a different machine-readable identifier technology.

### SUMMARY OF THE INVENTION

In one aspect, an exemplary embodiment of the present disclosure may provide a tracking apparatus. The tracking apparatus includes a main body that has a first end, a second end opposite to the first end, and a longitudinal axis defined therebetween. The tracking apparatus also includes a cavity that extends downwardly into the main body along an axis that is non-parallel to the longitudinal axis. The tracking apparatus also includes a tracking element encapsulated inside of the cavity and is free from being in contact with an external environment that is external to the main body. The main body is adapted to be mounted to a shipping unit.

In another aspect, an exemplary embodiment of the present disclosure may provide a tracking apparatus. The tracking apparatus includes a main body that has a first end, a second end opposite to the first end, and a longitudinal axis defined therebetween. The tracking apparatus also includes a cavity that extends downwardly into the main body along an axis that is non-parallel to the longitudinal axis. The tracking apparatus also includes at least one embedded fastener of the main body that is positioned at one of the first end and the second end. The tracking apparatus also includes a tracking element encapsulated inside of the cavity and is free from being in contact with an external environment that is external to the main body. The main body is adapted to be mounted to a shipping unit.

In yet another aspect, an exemplary embodiment of the present disclosure may provide a method of tracking a shipping unit with a tracking apparatus. The method includes steps of providing a tracking element of the tracking apparatus; positioning the tracking element inside of a cavity defined in a main body of the tracking apparatus; engaging at least one embedded fastener of the main body with the shipping unit; pressing the at least one embedded fastener of the main body into the shipping unit until the tracking element is prevented from escaping the cavity; and tracking the shipping unit with the tracking apparatus.

In yet another aspect, an exemplary embodiment of the present disclosure may provide a tracking apparatus. The tracking apparatus includes a main body having a first end, a second end opposite to the first end, and a longitudinal axis defined therebetween; a cavity that extends downwardly into the main body along an axis that is non-parallel to the longitudinal axis; and a tracking element encapsulated inside of the cavity and is free from being in contact with an external environment that is external to the main body; wherein the main body is adapted to be mounted to a shipping unit.

This exemplary embodiment or another exemplary embodiment may further include at least one fastener removably engageable with the main body configured to mount the main body to the shipping unit. This exemplary embodiment or another exemplary embodiment may further include at least one fastener operably engageable with the main body at one of the first end and the second end and is configured to mount the main body to the shipping unit. This exemplary embodiment or another exemplary embodiment may further include at least one opening defined in the main body, wherein the at least one opening is configured to receive the at least one fastener for mounting said main body to the shipping unit; wherein the at least one opening is free from being in communication with the cavity. This exemplary embodiment or another exemplary embodiment may further include that the main body further comprises: a base wall positioned between the first end and the second end; and an internal lateral wall extending outwardly from the base wall and positioned between the first end and the second end; wherein the base wall and the internal lateral wall collectively define the cavity. This exemplary embodiment or another exemplary embodiment may further include that the main body further comprises: a top end; a bottom end opposite to the top end; and a protrusion extending outwardly from the top end, wherein the protrusion is in communication with the internal lateral wall and the base wall. This exemplary embodiment or another exemplary embodiment may further include that the cavity is accessible from the bottom end only. This exemplary embodiment or another exemplary embodiment may further include a first opening defined in the main body at the first end; a second opening defined in the main body at the second end opposite to the first opening; wherein the cavity is defined between the first opening and the second opening and is free from being in communication with the first opening and the second opening. This exemplary embodiment or another exemplary embodiment may further include a pair of fasteners operably engageable with the main body at the first opening and the second opening; wherein the first opening and the second opening are configured to receive the pair of fasteners for mounting said main body to the shipping unit. This exemplary embodiment or another exemplary embodiment may further include that the tracking element is a radio-frequency identification (RFID) element.

In yet another aspect, an exemplary embodiment of the present disclosure may provide a tracking apparatus. The tracking apparatus includes a main body having a first end, a second end opposite to the first end, and a longitudinal axis defined therebetween; a cavity that extends downwardly into the main body along an axis that is non-parallel to the longitudinal axis; at least one fastener operably engaged with the main body at one of the first end and the second end; and a tracking element encapsulated inside of the cavity and is free from being in contact with an external environment that is external to the main body; wherein the main body is adapted to be mounted to a shipping unit.

This exemplary embodiment or another exemplary embodiment may further include that the main body further comprises: a base wall positioned between the first end and the second end; and an internal lateral wall extending outwardly from the base wall and positioned between the first end and the second end; wherein the base wall and the internal lateral wall collectively define the cavity. This exemplary embodiment or another exemplary embodiment may further include that the main body further comprises: a top end; a bottom end opposite to the top end; and a protrusion extending outwardly from the top end, wherein the protrusion is in communication with the internal lateral wall and the base wall. This exemplary embodiment or another exemplary embodiment may further include that the cavity is accessible from the bottom end only. This exemplary embodiment or another exemplary embodiment may further include a first opening defined in the main body at the first end; and a second opening defined in the main body at the second end opposite to the first opening; wherein the cavity is defined between the first opening and the second opening and is free from being in communication with the first opening and the second opening. This exemplary embodiment or another exemplary embodiment may further include a pair of fasteners operably engageable with the main body at the first opening and the second opening; wherein the first opening and the second opening are configured to receive the pair of fasteners for mounting said main body to the shipping unit.

In yet another aspect, an exemplary embodiment of the present disclosure may provide a method of tracking a shipping unit with a tracking apparatus. The method comprises steps of: providing a tracking element of the tracking apparatus; positioning the tracking element inside of a cavity defined in a main body of the tracking apparatus; engaging at least one fastener of the tracking apparatus with the main body; pressing the at least one fastener of the main body into the shipping unit until the tracking element is prevented from escaping the cavity; and tracking the shipping unit with the tracking apparatus.

This exemplary embodiment or another exemplary embodiment may further include steps of inserting the tracking element into the cavity at a bottom end of the main body; and reading the tracking element at a top end of the main body. This exemplary embodiment or another exemplary embodiment may further include that the step of engaging the at least one fastener with the main body further comprises: inserting the at least one fastener through at least one opening defined in the main body; and wherein the at least one opening and the cavity are free from being in communication with one another. This exemplary embodiment or another exemplary embodiment may further include that the step of engaging the at least one fastener with the main body further comprises: inserting a pair of fasteners through a pair of openings defined in the main body; wherein the pair of openings and the cavity are free from being in communication with one another.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a perspective view of a tracking apparatus in accordance with one aspect of the present disclosure, wherein the tracking apparatus is attached to a shipping unit.

FIG. 2 (FIG. 2) is a top, first end, second side perspective view of the tracking apparatus shown in FIG. 1.

FIG. 3 (FIG. 3) is a bottom, second end, second side perspective view of the tracking apparatus shown in FIG. 1.

FIG. 4 (FIG. 4) is an exploded view of the tracking apparatus shown in FIG. 1.

FIG. 5 (FIG. 5) is a top plan view of the tracking apparatus shown in FIG. 1.

FIG. 6 (FIG. 6) is a bottom plan view of the tracking apparatus shown in FIG. 1.

FIG. 7 (FIG. 7) is a first end elevation view of the tracking apparatus shown in FIG. 1.

FIG. 8A (FIG. 8A) is an operational view of the tracking apparatus being aligned with a wall of the shipping unit.

FIG. 8B (FIG. 8B) is an operational view continuing from FIG. 8A, wherein the tracking apparatus is force into the wall of the shipping unit to attach the tracking apparatus with the shipping unit.

FIG. 9 (FIG. 9) is a flowchart of a method of tracking a shipping unit with a tracking apparatus.

FIG. 10 (FIG. 10) is top, first end, second side perspective view of a tracking apparatus in accordance with another aspect of the present disclosure.

FIG. 11 (FIG. 11) is a bottom, second end, second side perspective view of the tracking apparatus shown in FIG. 10.

FIG. 12 (FIG. 12) is an exploded view of the tracking apparatus shown in FIG. 10.

FIG. 13 (FIG. 13) is a top plan view of the tracking apparatus shown in FIG. 10.

FIG. 14 (FIG. 14) is a bottom plan view of the tracking apparatus shown in FIG. 10.

FIG. 15 (FIG. 15) is a first end elevation view of the tracking apparatus shown in FIG. 10.

FIG. 16A (FIG. 16A) is an operational view of a pair of fasteners of the tracking apparatus being aligned a main body of the tracking apparatus.

FIG. 16B (FIG. 16B) is an operational view continuing from FIG. 8A, wherein the tracking apparatus is force into the wall of the shipping unit to attach the tracking apparatus with the shipping unit.

FIG. 17 (FIG. 17) is a flowchart of a method of tracking a shipping unit with a tracking apparatus.

Similar numbers refer to similar parts throughout the drawings.

### DETAILED DESCRIPTION

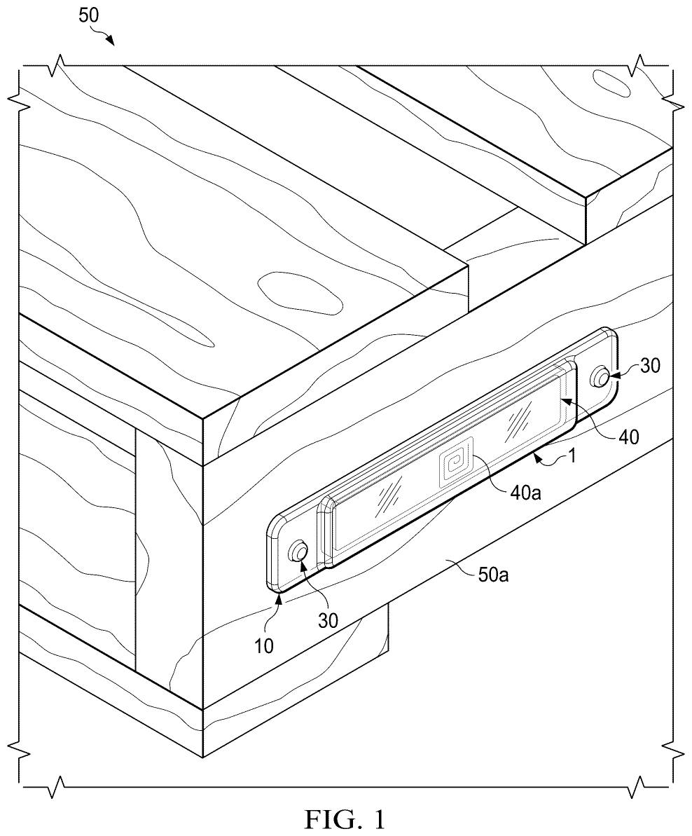

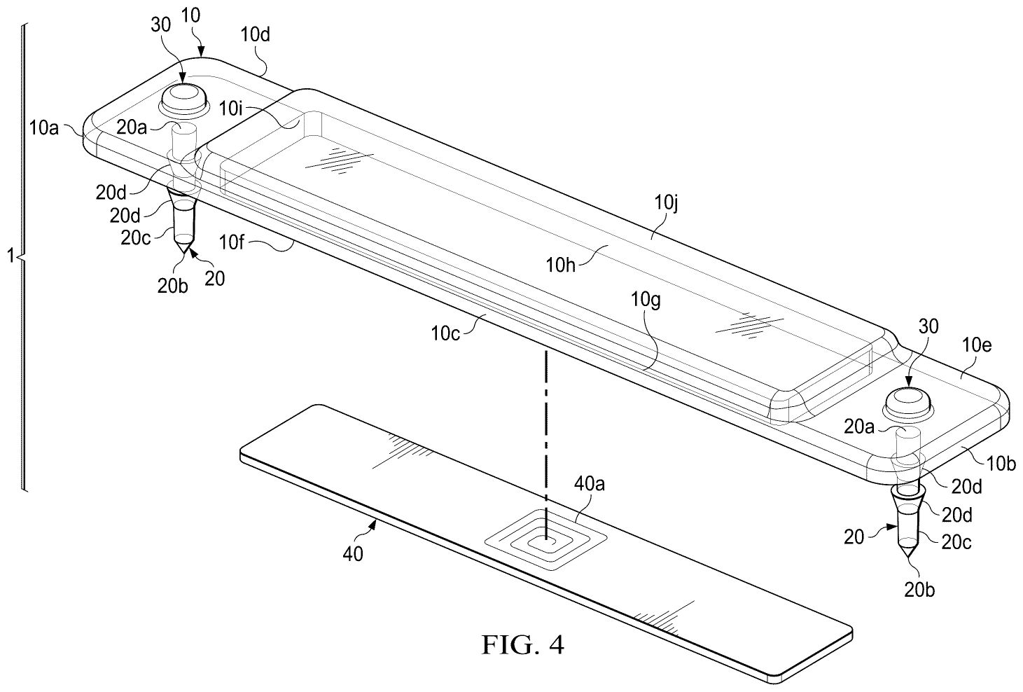

FIGS. 1-7 illustrate a tracking apparatus 1 that is operable to be engaged with a pallet or similar shipping unit that is intended to be logistically tracked. Such components of the tracking apparatus 1 are discussed in greater detail below.

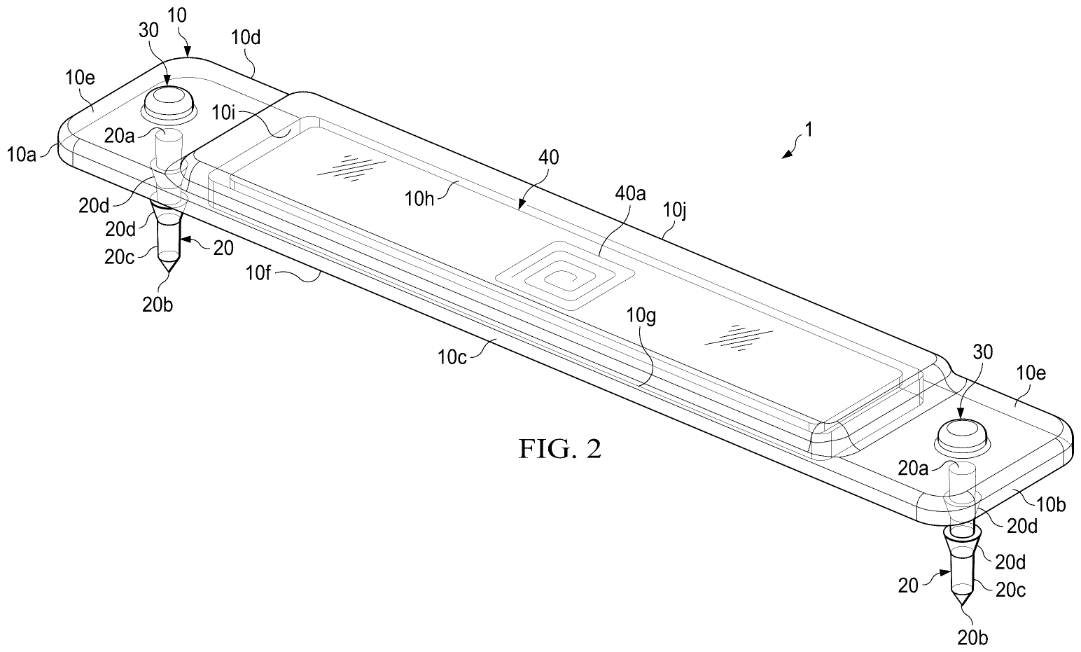

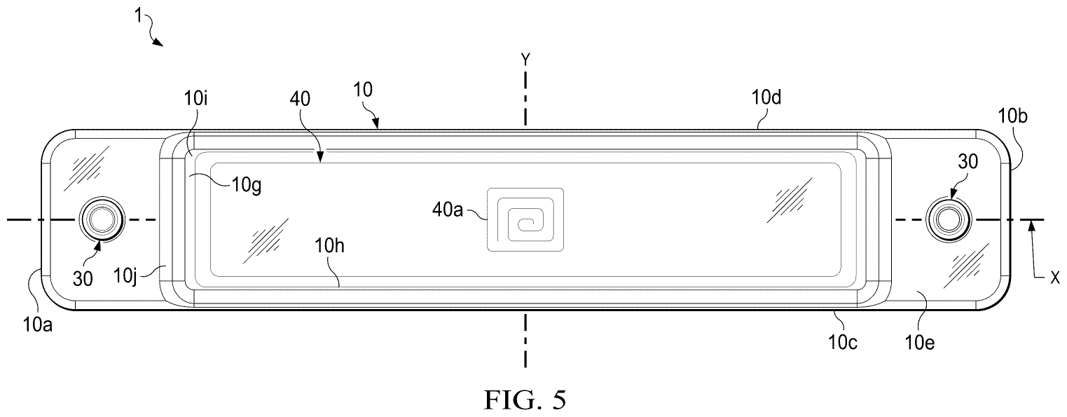

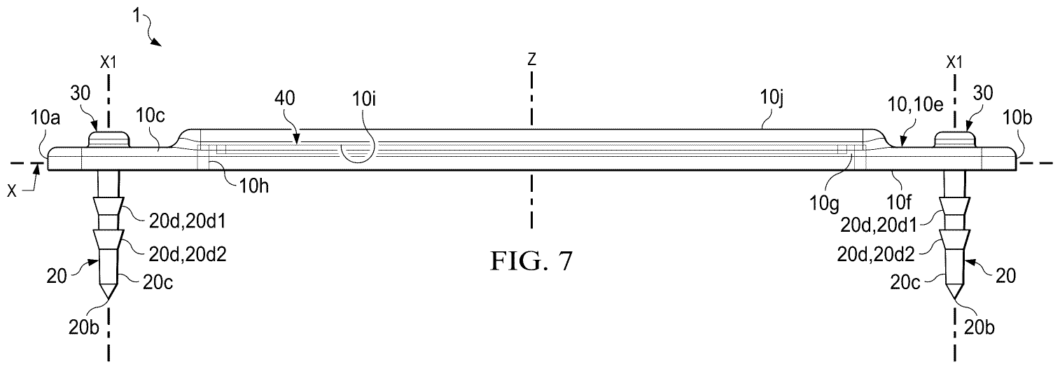

Tracking apparatus 1 includes a main body or housing 10. As best seen in FIG. 2, main body 10 includes a first end 10a, a second end 10b that is longitudinally opposite to the first end 10a, and a longitudinal axis that extends between the first end 10a and the second end 10b. The longitudinal axis of main body 10 is denoted by a dashed line labeled “X” in FIG. 5. Main body 10 also includes a first side 10c that is positioned between the first end 10a and the second end 10b, a second side 10d that is positioned between the first end 10a and the second end 10b and opposite to the first side 10c, and a transverse axis that extends between the first side 10c and the second side 10d. The transverse axis of main body 10 is denoted by a dashed line labeled “Y” in FIG. 5. In the present disclosure, the transverse axis “Y” is substantially perpendicular to the longitudinal axis “X” of main body 10. Main body 10 also includes a top end 10e, a bottom end 10f that is opposite to the top end 10e, and a vertical axis that extends between the top end 10e and the bottom end 10f. The transverse axis of main body 10 is denoted by a dashed line labeled “Z” in FIG. 7. In the present disclosure, the vertical axis “Z” is substantially perpendicular to the longitudinal axis “X” of main body 10.

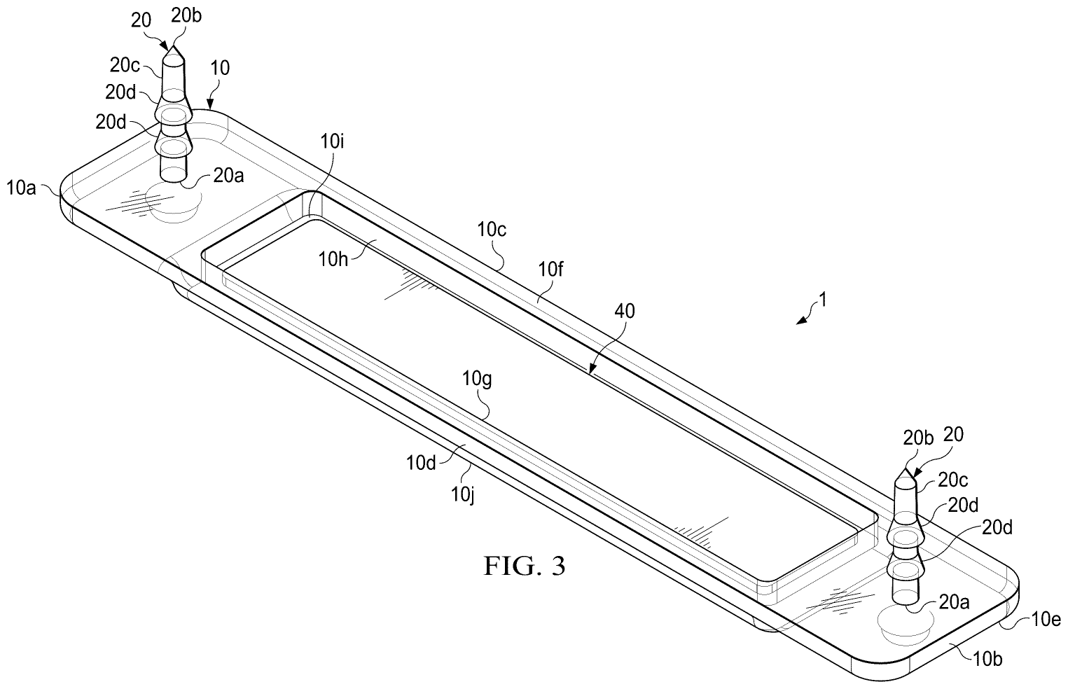

Still referring to main body 10, main body 10 also defines a cavity 10g. As best seen in FIG. 3, cavity 10g extends downwardly into the main body 10 along an axis that is parallel with the vertical axis “Z” of main body 10. Particularly, cavity 10g is defined by an internal lateral wall 10h that extends downwardly from the first side 10c to a base wall 10i. Due to such cavity 10g, main body 10 also includes a protrusion 10j that extends outwardly from the second side 10d to accommodate the cavity 10g. In the present disclosure, a portion of the top end 10e, the internal lateral wall 10h, and the base wall 10i form the protrusion 10j.

In the present disclosure, main body 10 has an oblong, rectangular shape when viewed from the top plan view (see FIG. 5). In other exemplary embodiments, main body 10 may have any suitable shape or structural configuration (when viewed from a top or bottom plan view) based on various reasons, including the shape of a tracking tag stored in the cavity 10g of the main body 10, the size, shape, or structural configuration of the pallet or shipping unit that the main body 10 is attached to, or other various reasons of the like. Examples of suitable shapes or structural configurations of a main body discussed herein include circular, triangular, square, pentagonal, hexagonal, heptagonal, octagonal, decagonal, dodecagonal, diamond shaped or another parallelogram, trapezoidal, star-shaped, oval, ovoid, teardrop-shaped, cross-shaped, donut-shaped, heart-shaped, arrow-shaped, crescent-shaped, or any other type of regular or irregular, symmetrical or asymmetrical configuration.

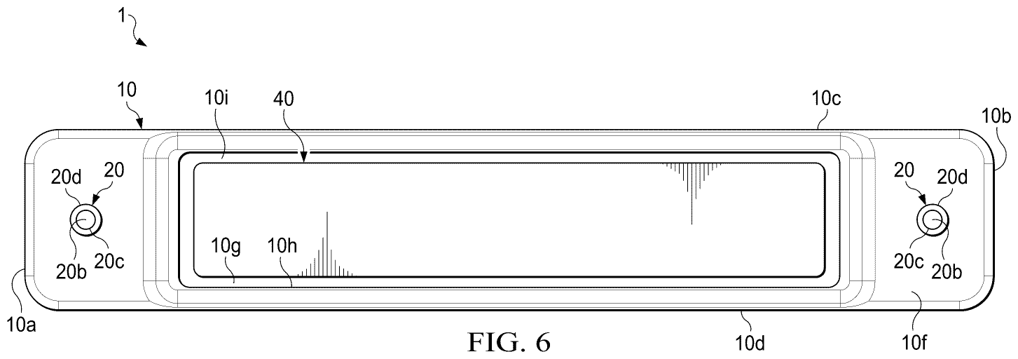

In the present disclosure, cavity 10g defined in the main body 10 also has an oblong, rectangular shape that matches with the shape of the main body 10 when viewed from a bottom plan view (see FIG. 6). In other exemplary embodiments, cavity 10g of the main body 10 may have an suitable shape or structural configuration (when viewed from a bottom plan view) based on various reasons, including the shape of a tracking tag stored in the cavity 10g of the main body 10, the size, shape, or structural configuration of the pallet or shipping unit that the main body 10 is attached to, or other various reasons of the like. Examples of suitable shapes or structural configurations of a main body discussed herein include circular, triangular, square, pentagonal, hexagonal, heptagonal, octagonal, decagonal, dodecagonal, diamond shaped or another parallelogram, trapezoidal, star-shaped, oval, ovoid, teardrop-shaped, cross-shaped, donut-shaped, heart-shaped, arrow-shaped, crescent-shaped, or any other type of regular or irregular, symmetrical or asymmetrical configuration.

In the present disclosure, the shape of the main body 10 and the cavity 10g defined by the main body 10 are symmetrical to one another when viewed from a plan view (e.g., a bottom plan view). In other exemplary embodiments, the shape of the main body 10 and the cavity 10g defined by the main body 10 may be different to one another or be asymmetrical to one another for various reasons, including the shape of a tracking tag stored in the cavity 10g of the main body 10, the size, shape, or structural configuration of the pallet or shipping unit that the main body 10 is attached to, or other various reasons of the like. In one example, the main body 10 has a first shape (e.g., one of the exemplary shapes listed previously) when viewed from a plan view, and the cavity 10g of the main body 10 has a second shape (e.g., one of the exemplary shapes listed previously) when viewed from a plan view in which the second shape is different from the first shape of the main body 10.

In the present disclosure, main body 10 defines a single cavity 10g for housing and protecting a tracking tag, which is discussed in greater detail below. In other exemplary embodiments, main body 10 may define any suitable number of cavities or similar voids based on various reasons, including the number of tracking tags needed for a given pallet or shipping unit. Examples of suitable numbers of cavities defined in a main body include, one, at least one, a plurality, two, three, four, five, and any other suitable number of cavities defined in a main body.

In the present disclosure, main body 10 is made of a transparent material or clear material that transmits light through the entire main body 10 without appreciably scattering such light so that components or elements housed inside of main body 10 are visible and seen clearly. In one example, main body 10 may be formed of a plastic or polymer material that is transparent so that components or elements housed inside of main body 10 are visible and seen clearly. In one example, main body 10 may be formed of a glass or similar material that is transparent so that components or elements housed inside of main body 10 are visible and seen clearly. In other exemplary embodiments, main body 10 may also be made from a translucent material or opaque material that may diffuse light entering into the main body 10 causing such tracking components or elements housed inside of the main body 10 to not be clearly seen; such exemplary embodiments may be desirable if the tracking tags or components housed inside of the main body 10 are not required to be visible when scanned or examined during logistic operations.

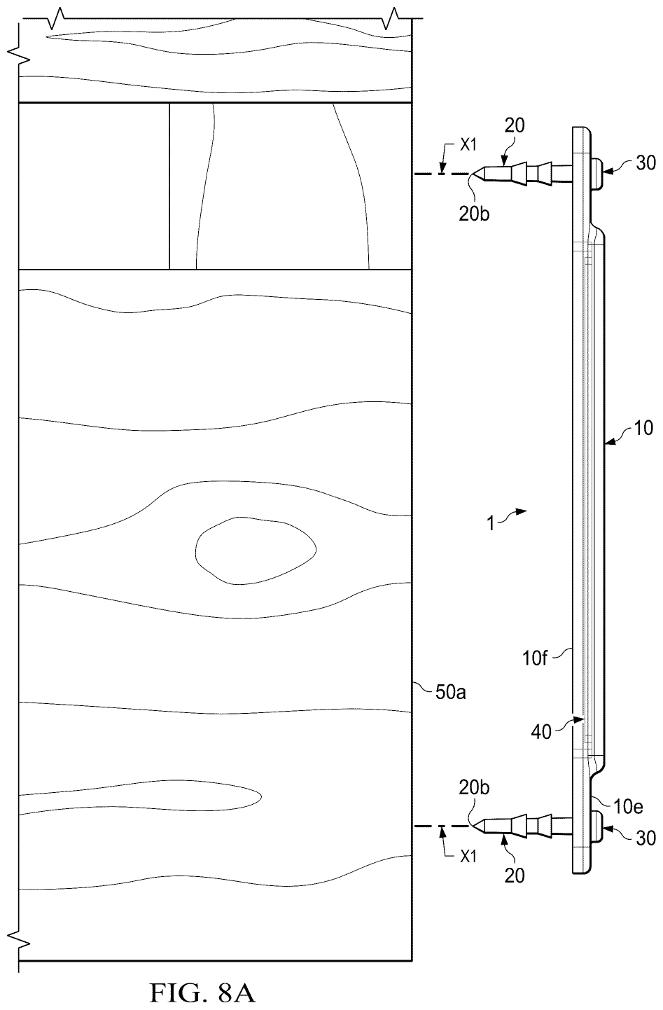

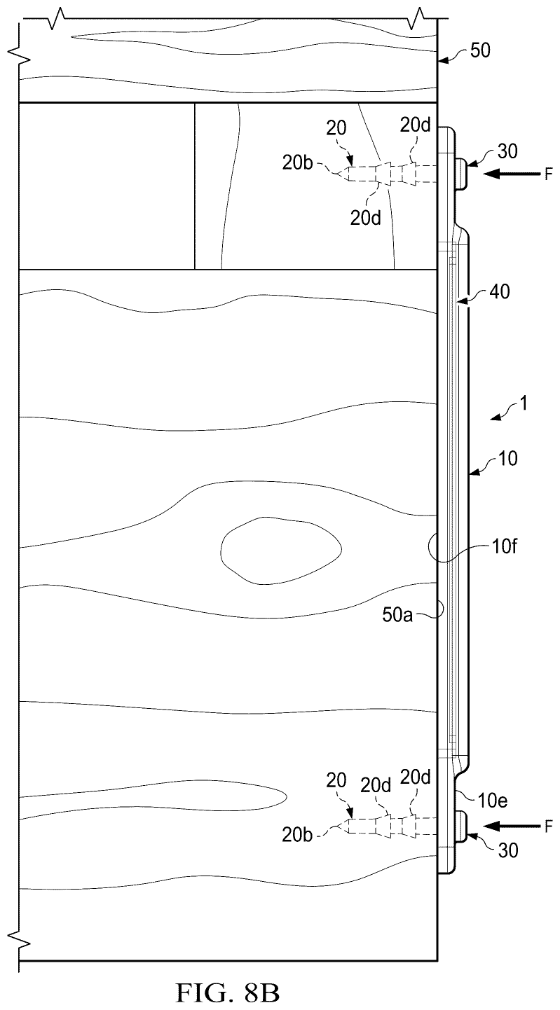

Tracking apparatus 1 also includes at least one fastener 20 that is formed with main body 10. As best seen in FIGS. 2-4 and 8A-8B, tracking apparatus 1 includes a pair of fasteners 20 where each fastener of the pair of fasteners 20 is formed in the main body 10. As best seen in FIG. 7, each fastener of the pair of fasteners 20 has a base 20a that is formed with the second side 10d of the main body 10, a tip 20b that is opposite to the base 20a and spaced apart from the main body 10, and a shaft 20c that extends between the base 20a and the tip 20b. Each fastener of the pair of fasteners 20 also defines a longitudinal axis that extends along the entire shaft 20c between the base 20a and the tip 20b; such longitudinal axis is denoted by dashed lines labeled “X1” in FIGS. 7 and 8A.

Each fastener of the pair of fasteners 20 includes at least one rib 20d that extends outwardly from the shaft 20c at a position between the base 20a and the tip 20b. In the present disclosure, each fastener of the pair of fasteners 20 includes a pair of ribs 20d1, 20d2 that extends outwardly from the shaft 20c where a first rib 20d1 is located at a first position between the base 20a and the tip 20b, and a second rib 20d2 is located at a second position between the first rib 20d1 and the tip 20b.

As discussed above, tracking apparatus 1 includes the pair of fasteners 20 where each fastener 20 is formed with main body 10. In other exemplary embodiments, any suitable number of fasteners may be included and formed with main body 10 for various reasons, including the shape, size, and structural configuration of the main body 10, the size, shape, or structural configuration of the pallet or shipping unit that the main body 10 is intended to be attached to, or other various reasons of the like. Examples of suitable numbers of fasteners included and formed with main body 10 include, one, at least one, a plurality, two, three, four, five, and any other suitable number of fasteners included and formed with main body 10.

In the present disclosure, each fastener of the pair of fasteners 20 is formed of and/or made from the same material of the main body 10; as such, any material that the main body 10 may be made from as discussed herein apply equally to the material that would form each fastener of the pair of fasteners 20. In other exemplary embodiments, each fastener of the pair of fasteners 20 may be formed and/or made of any suitable materials that may attach the tracking apparatus 1 to a pallet or similar shipping unit. In one exemplary embodiment, each fastener of the pair of fasteners 20 may be formed from and/or made of a different material than the material that forms main body 10. In this exemplary embodiment, each fastener of the pair of fasteners 20 may be formed and/or made of metal or metal alloy(s) that may attach the tracking apparatus 1 to a pallet or similar shipping unit. In another exemplary embodiment, each fastener of a pair of fasteners may also be separable and/or independent of a main body when each fastener of the pair of fasteners is formed from a different material than that of the material that formed main body. In this exemplary embodiment, main body may then be configured to receive each fastener of the pair of fasteners (e.g., via openings, apertures, or similar voids defined in main body) so that each fastener of the pair of fasteners may attach and engage the main body 10 with a pallet or similar shipping unit.

In the present disclosure, each fastener of the pair of fasteners 20 includes the pair of ribs 20d. In other exemplary embodiments, each fastener of the pair of fasteners 20 may define any suitable number of ribs 20d based on various reasons, including the length of the each fastener. Examples of suitable numbers of ribs that are formed in each fastener of a pair of fasteners include, one, at least one, a plurality, two, three, four, five, and any other suitable number of ribs that are formed in each fastener of a pair of fasteners.

In the present disclosure, each rib of the pair of ribs 20d has a triangular shape when viewed from a side elevation view (see FIG. 7) and/or a conical shape when viewed from a perspective view (see FIG. 2). Such triangular and/or conical shape of the ribs 20d is advantageous because such shape allows a user to drive the fasteners 20 into a wall of a pallet or shipping unit with ease while also preventing the fasteners 20 from backing out of or retreating from the wall of the shipping unit. In other exemplary embodiments, each rib of the pair of ribs 20d may have an suitable shape or structural configuration (when viewed from an elevation view of perspective view) based on various reasons, including the material that used to create the pallet or similar shipping unit. Examples of suitable shapes or structural configurations of a rib formed on a fastener discussed herein include circular, triangular, square, pentagonal, hexagonal, heptagonal, octagonal, decagonal, dodecagonal, diamond shaped or another parallelogram, trapezoidal, star-shaped, oval, ovoid, teardrop-shaped, cross-shaped, donut-shaped, heart-shaped, arrow-shaped, crescent-shaped, or any other type of regular or irregular, symmetrical or asymmetrical configuration.

Each fastener of the pair of fasteners 20 may also include additional attachment means or features to assist a user or operator in attaching the tracking apparatus 1 to a pallet or similar shipping unit. In one example, each fastener of a pair of fasteners may have external threads that may grip with the pallet or shipping unit as the tracking apparatus 1 is attached. In this example, each fastener of the pair of fasteners may need to be freely rotatable about its own longitudinal axis “X1” relative to main body 10.

Tracking apparatus 1 also includes at least one button 30 that is formed with the main body 10 and is coaxial with the at least one fastener 20. In the present disclosure, tracking apparatus 1 includes a pair of buttons 30 that is formed with the main body 10 and is coaxial with a respective fastener of the pair of fasteners 20. As best seen in FIG. 7, each button of the pair of buttons 30 extends outwardly from the first side 10c of main body 10 and is coaxial with the respective fastener 20 relative to the longitudinal axis “X1” of the respective fastener 20. When attaching tracking apparatus 1 to a pallet or similar shipping unit, each button of the pair of buttons 30 may act as an indicator or marker as to where the respective fastener 20 is located so a suitable amount of force may be applied at the correct location on the main body 10; such attachment of tracking apparatus 1 to a pallet or similar shipping unit is discussed in greater detail below.

It should be understood that each button of the pair of buttons 30 may have any suitable structural configuration based on the amount of force or pressure applied to each button of the pair of buttons 30 for attaching the tracking apparatus 1 to a pallet or similar shipping unit. In one example, each button of the pair of buttons 30 may have a first structural configuration where force or pressure applied to each button of the pair of buttons 30 is from an operator's fingers or hand to attach the tracking apparatus 1 to a pallet or similar shipping unit. In another example, each button of the pair of buttons 30 may have a second structural configuration where force or pressure applied to each button of the pair of buttons 30 is from an external tool or implement (e.g., hammer, mallet, or similar tools of the like) swung by an operator to attach the tracking apparatus 1 to a pallet or similar shipping unit; in this example, the second structural configuration would be denser and/or stronger as compared to the first structural configuration discussed previously.

Tracking apparatus 1 also includes tracking tag or tracking element 40. As best seen in FIG. 2, the tracking element 40 is housed completely inside of the cavity 10g of main body 10. Tracking element 40 may also include a machine-readable identifier 42 that is visible inside of the cavity 10g. In the present disclosure, the identifier 42 is a radio-frequency identification tag (or RFID tag) that may be encoded with information or data relating to cargo that is loaded on the pallet or shipping unit. In other exemplary embodiments, identifier 42 of the tracking element 40 may include any machine-readable form identifier that may be encoded with information or data relating to cargo or material that is loaded on the pallet or shipping unit. Examples of visible machine-readable form identifier that may be included on a tracking element include, but are not limited to, barcodes, quick-response codes or QR codes, and other suitable machine-readable form identifiers that may be encoded with information or data relating to cargo or material that is loaded on the pallet or shipping unit.

Having now discussed the components of tracking apparatus 1, a method of installing the tracking apparatus 1 to a pallet or similar shipping unit is discussed in greater detail below.

Prior to attaching the tracking apparatus 1 to a shipping unit 50, an operator or user must introduce and house the tracking element 40 inside of the cavity 10g of main body 10. In one example, the operator arranges the tracking element 40 inside of the cavity 10g of main body 10 in such a way that the identifier 42 is visible through the base wall 10i of main body 10; such example is illustrated herein. In another example, the operator may arrange the tracking element 40 inside of the cavity 10g of main body 10 in such a way that the identifier 42 is not visible through the base wall 10i of main body 10; such arrangement may be preferred or allowed if an external reading device does not require a clear view of the identifier 42 and uses other means of scanning said identifier 42 (e.g., using radio-frequency elements). While not illustrated herein, the tracking element 40 may also be adhered to and/or bonded to the main body 10 inside of the cavity 10g if desired by the operator.

Once the tracking element 40 is housed inside of the main body 10, the operator may then introduce the tracking apparatus 1 to the shipping unit 50. As best seen in FIG. 8A, the user aligns the tracking apparatus 1 with a desired wall 50a of shipping unit 50. At this stage, each fastener of the pair of fasteners 20 is pointing directly at the desired wall 50a of shipping unit 50 such that the longitudinal axis “X1” of each fastener of the pair of fasteners 20 is orthogonal to the desired wall 50a. Once aligned, the user may then apply a force onto main body 10 to attach and secure the tracking apparatus 1 with the wall 50a of shipping unit 50 via the pair of fasteners 20. In the present disclosure, and as best seen in FIG. 8B, the user applies force at the pair of buttons 30 so that the force is directly aligned with the pair of fasteners 20; such force applied by the user is denoted by arrows labeled “F” in FIG. 8B. As discussed above, the force applied by the user may be directly from the user's extremities (e.g., user's hands) or through a tool swung or operated by the user (e.g., hammer, mallet, or similar tool).

Once the tracking apparatus 1 is attached with the shipping unit 50, the second side 10d of main body 10 is flush with and directly contacting the wall 50a of shipping unit 50. With such arrangement, the tracking element 40 is positioned between main body 10 and the wall 50a of shipping unit 50; as such, the tracking element 40 is encapsulated and is free from being in communication with the external environment surrounding main body 10 and shipping unit 50. Such arrangement may be desirable to prevent the tracking element 42 from escaping the cavity 10g of main body 10, prevent unwanted external material or precipitation from interfering with the tracking element 40, and other various reasons of the like. Additionally, the pair of fasteners 20 are completely seated in the wall 50a of the shipping unit 50 to maintain the tracking apparatus 1 with the shipping unit 50. It should be noted that the pair of ribs 20d of each fastener of the pair of fasteners 20 prevent the fasteners 20 from backing out or retreating from the shipping unit 50.

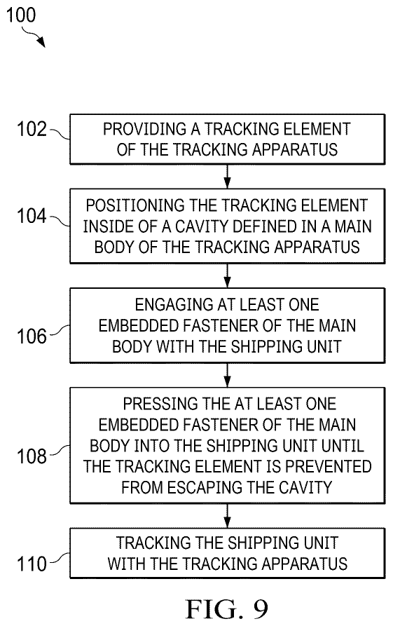

FIG. 9 illustrates a method 100 of tracking a shipping unit with a tracking apparatus. An initial step 102 of method 100 includes providing a tracking element of the tracking apparatus. Another step 104 of method 100 includes positioning the tracking element inside of a cavity defined in a main body of the tracking apparatus. Another step 106 of method 100 includes engaging at least one embedded fastener of the main body with the shipping unit. Another step 108 of method 100 includes pressing the at least one embedded fastener of the main body into the shipping unit until the tracking element is prevented from escaping the cavity. Another step 110 of method 100 includes tracking the shipping unit with the tracking apparatus.

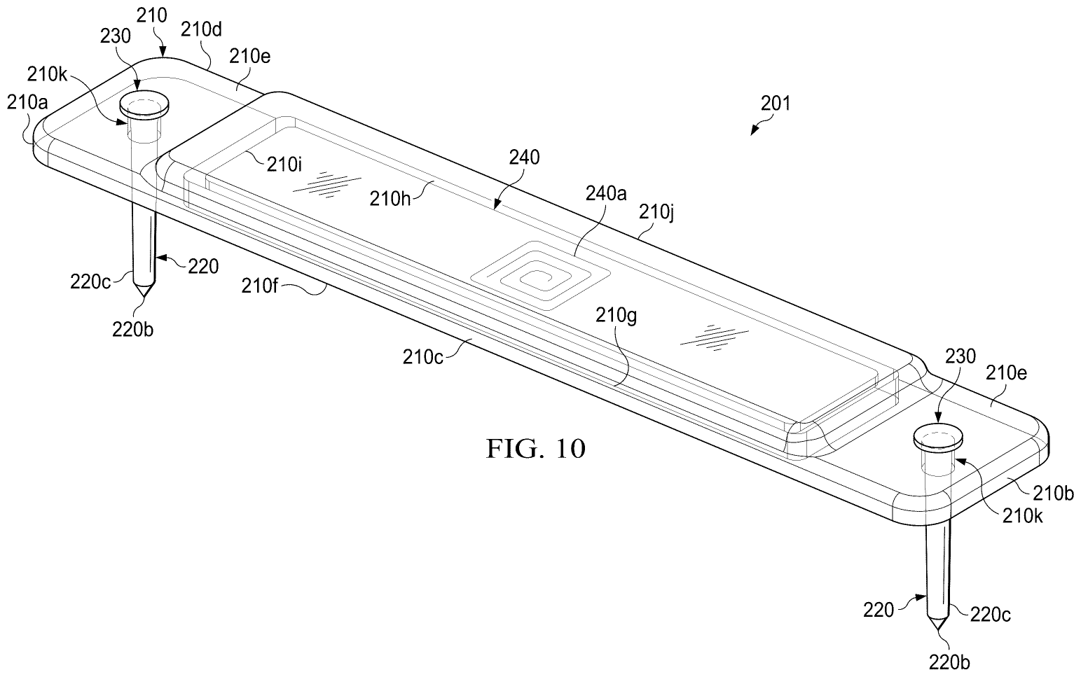

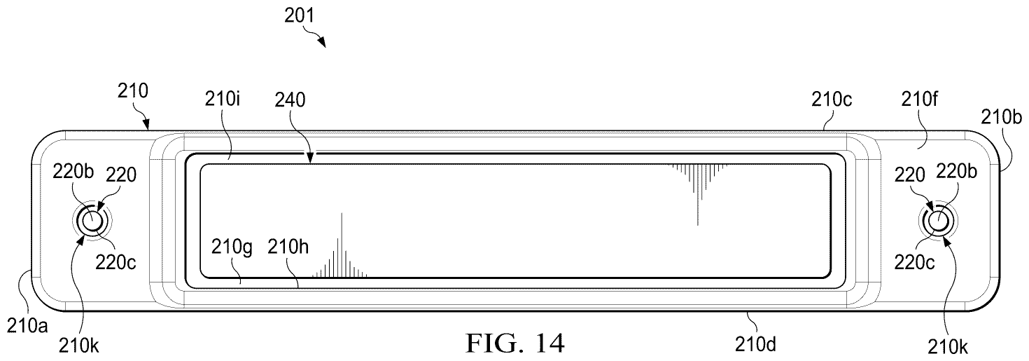

FIGS. 10-16B illustrate another tracking apparatus 201 that is operable to be engaged with a pallet or similar shipping unit that is intended to be logistically tracked.

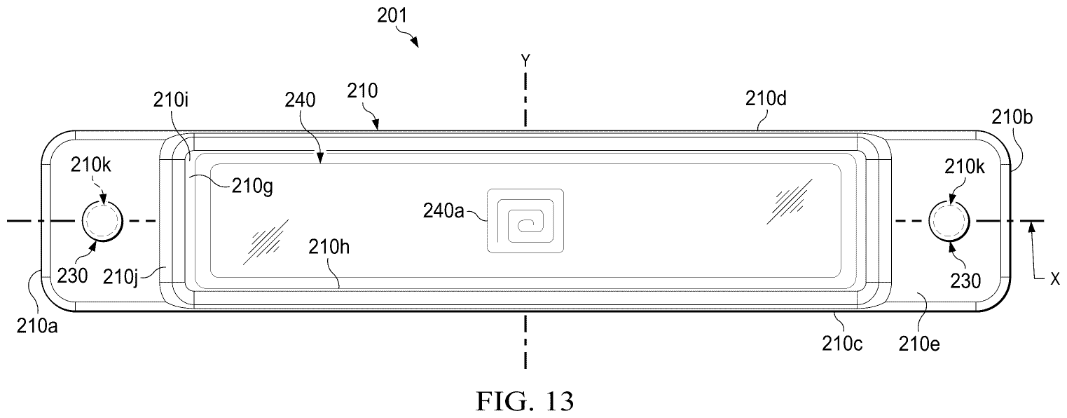

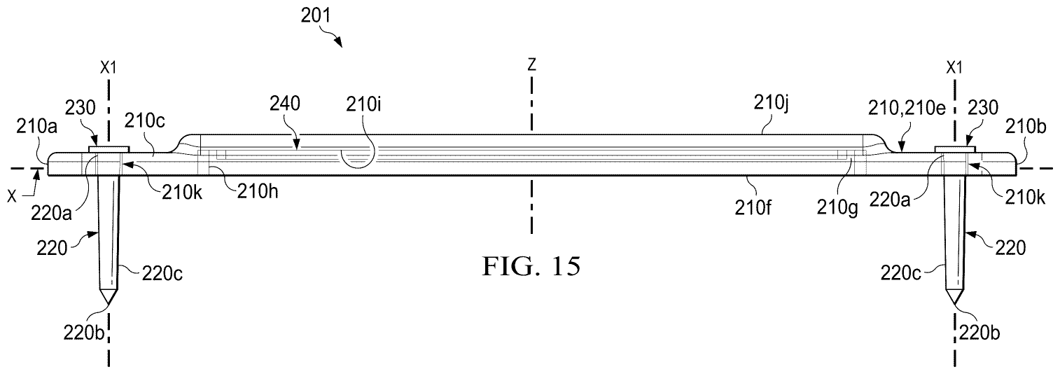

In this embodiment, tracking apparatus 201 includes a main body or housing 210 that is substantially similar to main body 10 of tracking apparatus 1. As such, main body 210 includes a first end 210a, a second end 210b, and a longitudinal axis “X” (see FIGS. 13 and 15) that extends between the first end 210a and the second end 210b that are identical to the first end 10a, second end 10b, and longitudinal axis “X” of main body 10 of tracking apparatus 1 mentioned above. Main body 210 also includes a first side 210c, a second side 210d, and a transverse axis “Y” (see FIG. 13) that extends between the first side 210c and the second side 210d that are identical to first side 10c, second side 10d, and transverse axis “Y” that extends between the first side 10c and the second side 10d of main body 10 of tracking apparatus 1 mentioned above. Main body 210 also includes a top end 210e, a bottom end 210f, and a vertical axis “Z” (see FIG. 15) extending between the top end 210e and the bottom end 210f that are identical to the top end 10e, bottom end 10f, and vertical axis “Z” extending between the top end 10e and the bottom end 10f of main body 10 of tracking apparatus 1 mentioned above. Main body 210 also includes a cavity 210g that is collectively defined by an internal lateral wall 210h, a base wall 210i, and a protrusion 210j that are identical to the cavity 10g collectively defined by internal lateral wall 10h, base wall 10i, and protrusion 10j of main body 10 of tracking apparatus 1 mentioned above.

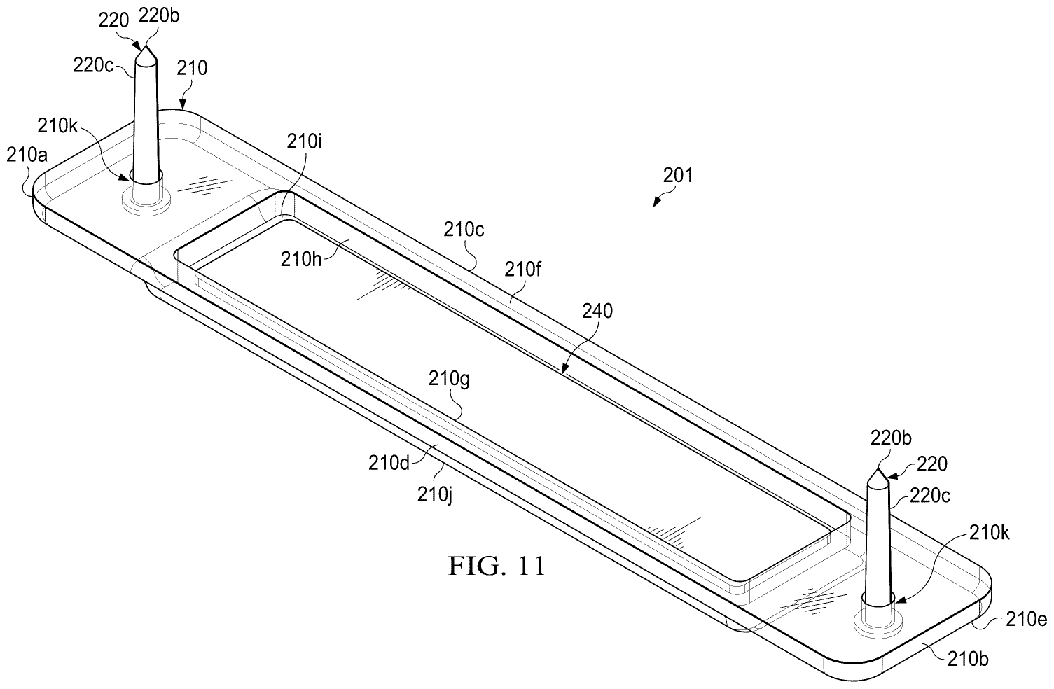

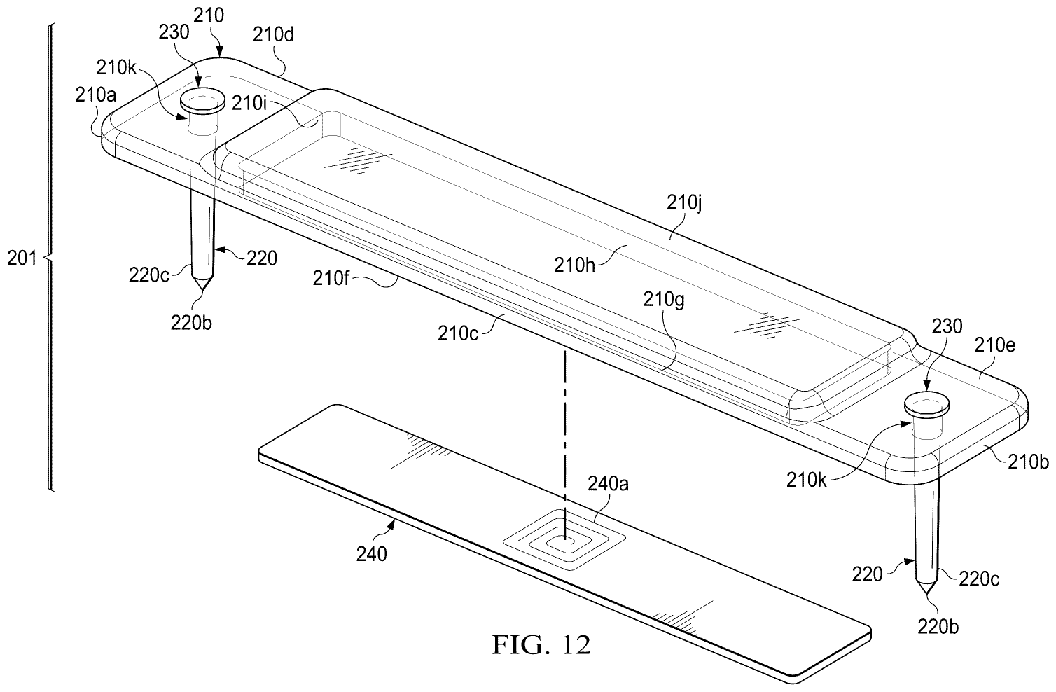

However, in this embodiment, main body 210 also defines at least one opening at a position remote from the cavity 210g. As best seen in FIGS. 11-12, main body 210 defines a pair of openings 210k where a first opening of the pair of openings 210k is defined at the first end 210a of the main body 210 and a second opening of the pair of openings 210k is defined at the second end 210b of the main body 210. The pair of openings 210k is also spaced apart from the cavity 210g to which the cavity 210g and the pair of openings 210k are free from being in communication with one another. It should be noted that each opening of the pair of openings 210k also extends entirely through the main body 210 along the vertical axis “Z” of main body 210 between the top end 210e and the bottom end 210f; as such, the top end 210e and the bottom end 210f of the main body 210 are in communication with one another at each opening of the pair of openings 210k. Such use and purpose of the pair of openings 210k is discussed in greater detail below.

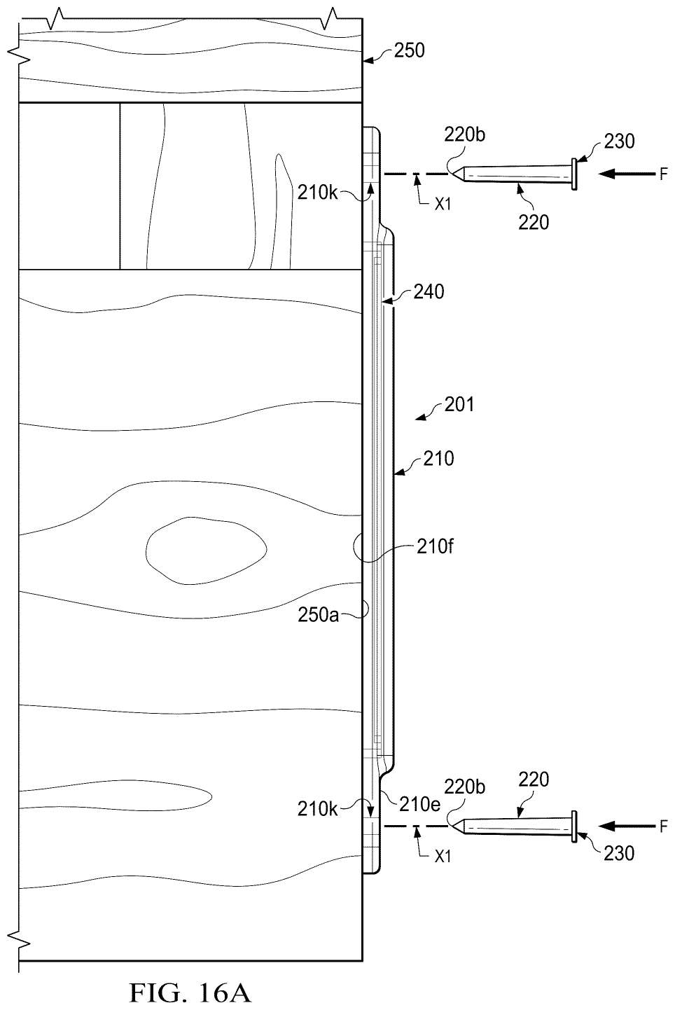

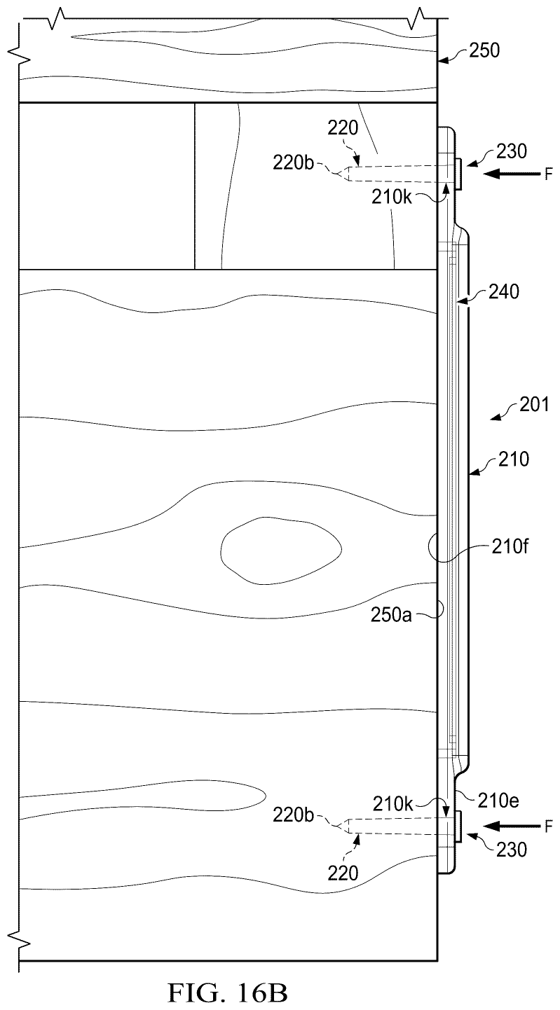

Tracking apparatus 201 also includes at least one fastener 220 that is removably engaged with main body 210. As best seen in FIGS. 10-16B, tracking apparatus 201 includes a pair of fasteners 220 where each fastener of the pair of fasteners 220 is removably engaged with main body 210. As best seen in FIG. 15, each fastener of the pair of fasteners 220 has a base or head 220a that operably engages with the top end 210e of main body 210, a tip 220b that is opposite to the base 220a and spaced apart from the main body 210, and a shaft 220c that extends between the base 220a and the tip 220b. Each fastener of the pair of fasteners 220 also defines a longitudinal axis that extends along the entire shaft 220c between the base 220a and the tip 220b; such longitudinal axis is denoted by dashed lines labeled “X1” in FIGS. 15 and 16A.

In operation, each fastener of the pair of fasteners 220 operably engages with the main body 210 at the pair of openings 210k (see FIG. 16B). As such, the pair of openings 210k receives the pair of fasteners 220 to mount the main body 210 to a shipping unit, which is discussed in greater detail below. It should be understood that while a pair of fasteners 220 mount the main body 210 to a shipping unit, a single fastener may also operably engage the main body 210 to a shipping unit if a single fastener is only needed.

In this embodiment, each fastener of the pair of fasteners 220 is illustrated as a commercially-available nail. It should be understood that other suitable fasteners or connectors may be used to mount or attach a main body of a tracking apparatus mentioned herein to a desired shipping unit. Examples of suitable fasteners or connectors for mounting or attaching a main body of a tracking apparatus mentioned herein to a desired shipping unit include screws, bolts with corresponding retaining nuts, rivets, anchors, and other suitable fasteners or connectors for mounting or attaching a main body of a tracking apparatus mentioned herein to a desired shipping unit.

Tracking apparatus 201 also includes tracking tag or tracking element 240 identical to tracking element 40 of tracking apparatus 1. As best seen in FIG. 11, the tracking element 240 is housed completely inside of the cavity 210g of main body 210. Tracking element 240 may also include a machine-readable identifier 242 that is visible inside of the cavity 210g. In the present disclosure, the identifier 242 is a radio-frequency identification tag (or RFID tag) that may be encoded with information or data relating to cargo that is loaded on the pallet or shipping unit. In other exemplary embodiments, identifier 242 of the tracking element 240 may include any machine-readable form identifier that may be encoded with information or data relating to cargo or material that is loaded on the pallet or shipping unit. Examples of visible machine-readable form identifier that may be included on a tracking element include, but are not limited to, barcodes, quick-response codes or QR codes, and other suitable machine-readable form identifiers that may be encoded with information or data relating to cargo or material that is loaded on the pallet or shipping unit.

Having now discussed the components of tracking apparatus 201, a method of installing the tracking apparatus 201 to a pallet or similar shipping unit is discussed in greater detail below.

Prior to attaching the tracking apparatus 201 to a shipping unit 250, an operator or user must introduce and house the tracking element 240 inside of the cavity 210g of main body 210. In one example, the operator arranges the tracking element 240 inside of the cavity 210g of main body 210 in such a way that the identifier 242 is visible through the base wall 210i of main body 210; such example is illustrated herein. In another example, the operator may arrange the tracking element 240 inside of the cavity 210g of main body 210 in such a way that the identifier 242 is not visible through the base wall 210i of main body 210; such arrangement may be preferred or allowed if an external reading device does not require a clear view of the identifier 242 and uses other means of scanning said identifier 242 (e.g., using radio-frequency elements). While not illustrated herein, the tracking element 240 may also be adhered to and/or bonded to the main body 210 inside of the cavity 210g if desired by the operator.

Once the tracking element 240 is housed inside of the main body 210, the operator may then introduce the tracking apparatus 201 to the shipping unit 250. As best seen in FIG. 16A, the user aligns the tracking apparatus 201 with a desired wall 250a of shipping unit 250. At this stage, each fastener of the pair of fasteners 220 is pointing directly at main body 210 and at the desired wall 250a of shipping unit 250 such that the longitudinal axis “X1” of each fastener of the pair of fasteners 220 is orthogonal to the longitudinal axis “X” of main body 210 and the desired wall 250a. Once aligned, the user may then insert the pair of fasteners 220 into the main body 210 (at the pair of openings 210k) and apply a force onto the pair of fasteners 220 to attach and secure the tracking apparatus 201 with the wall 250a of shipping unit 250 via the pair of fasteners 220. In the present disclosure, and as best seen in FIG. 16B, the user applies force heads 220a of the pair of fasteners 220 so that the force is directly aligned with the pair of fasteners 220; such force applied by the user is denoted by arrows labeled “F” in FIG. 16B. As discussed above, the force applied by the user may be directly from the user's extremities (e.g., user's hands) or through a tool swung or operated by the user (e.g., hammer, mallet, or similar tool). If other fasteners or connectors are used requiring torque, a user may apply torque or rotational force on the fasteners by a tool (e.g., screwdriver, powered drill, etc.) to the secure the fasteners to the shipping unit.

Once the tracking apparatus 201 is attached with the shipping unit 250, the second side 210d of main body 210 is flush with and directly contacting the wall 250a of shipping unit 250. With such arrangement, the tracking element 240 is positioned between main body 210 and the wall 250a of shipping unit 250; as such, the tracking element 240 is encapsulated and is free from being in communication with the external environment surrounding main body 210 and shipping unit 250. Such arrangement may be desirable to prevent the tracking element 242 from escaping the cavity 210g of main body 210, prevent unwanted external material or precipitation from interfering with the tracking element 240, and other various reasons of the like. Additionally, the pair of fasteners 220 are completely seated in the wall 250a of the shipping unit 250 to maintain the tracking apparatus 201 with the shipping unit 250. It should be noted that a pair of ribs or anchors may be included with each fastener of the pair of fasteners 220 prevent the fasteners 220 from backing out or retreating from the shipping unit 250 if desired.

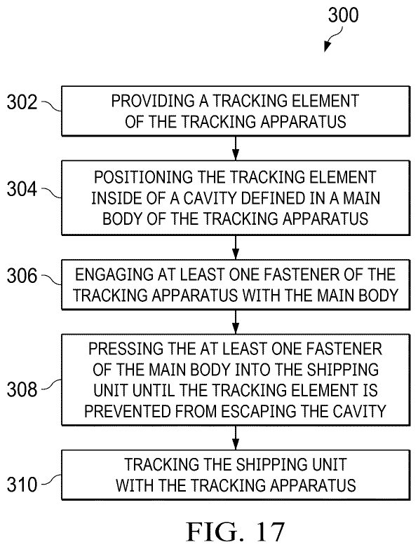

FIG. 17 illustrates a method 300 of tracking a shipping unit with a tracking apparatus. An initial step 302 of method 300 includes providing a tracking element of the tracking apparatus. Another step 304 of method 300 includes positioning the tracking element inside of a cavity defined in a main body of the tracking apparatus. Another step 306 of method 300 includes engaging at least one fastener of the tracking apparatus with the main body. Another step 308 of method 300 includes pressing the at least one fastener of the main body into the shipping unit until the tracking element is prevented from escaping the cavity. Another step 310 of method 300 includes tracking the shipping unit with the tracking apparatus.

In other exemplary embodiments, additional or optional steps may be further included with method 300 of tracking a shipping unit with a tracking apparatus. In one exemplary embodiment, method 300 may further include steps of inserting the tracking element into the cavity at a bottom end of the main body; and reading the tracking element at a top end of the main body. In another exemplary embodiment, method 300 may further include that the step of engaging the at least one fastener with the main body further comprises: inserting the at least one fastener through at least one opening defined in the main body; and wherein the at least one opening and the cavity are free from being in communication with one another. In another exemplary embodiment, method 300 may further include that the step of engaging the at least one fastener with the main body further comprises: inserting a pair of fasteners through a pair of openings defined in the main body; wherein the pair of openings and the cavity are free from being in communication with one another.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A tracking apparatus, comprising:
a main body having a first end, a second end opposite to the first end, and a longitudinal axis defined therebetween;
a cavity that extends downwardly into the main body along an axis that is non-parallel to the longitudinal axis; and
a tracking element encapsulated inside of the cavity and is free from being in contact with an external environment that is external to the main body;
wherein the main body is adapted to be mounted to a shipping unit.

2. The tracking apparatus of claim 1, further comprising:
at least one fastener removably engageable with the main body configured to mount the main body to the shipping unit.

3. The tracking apparatus of claim 1, further comprising:
at least one fastener operably engageable with the main body at one of the first end and the second end and is configured to mount the main body to the shipping unit.

4. The tracking apparatus of claim 2, further comprising:
at least one opening defined in the main body, wherein the at least one opening is configured to receive the at least one fastener for mounting said main body to the shipping unit;
wherein the at least one opening is free from being in communication with the cavity.

5. The tracking apparatus of claim 1, wherein the main body further comprises:
a base wall positioned between the first end and the second end; and
an internal lateral wall extending outwardly from the base wall and positioned between the first end and the second end;
wherein the base wall and the internal lateral wall collectively define the cavity.

6. The tracking apparatus of claim 5, wherein the main body further comprises:
a top end;
a bottom end opposite to the top end; and
a protrusion extending outwardly from the top end, wherein the protrusion is in communication with the internal lateral wall and the base wall.

7. The tracking apparatus of claim 6, wherein the cavity is accessible from the bottom end only.

8. The tracking apparatus of claim 1, further comprising:
a first opening defined in the main body at the first end; and
a second opening defined in the main body at the second end opposite to the first opening;
wherein the cavity is defined between the first opening and the second opening and is free from being in communication with the first opening and the second opening.

9. The tracking apparatus of claim 8, further comprising:
a pair of fasteners operably engageable with the main body at the first opening and the second opening;
wherein the first opening and the second opening are configured to receive the pair of fasteners for mounting said main body to the shipping unit.

10. The tracking element of claim 1, wherein the tracking element is a radio-frequency identification (RFID) element.

11. A tracking apparatus, comprising:
a main body having a first end, a second end opposite to the first end, and a longitudinal axis defined therebetween;
a cavity that extends downwardly into the main body along an axis that is non-parallel to the longitudinal axis;
at least one fastener operably engaged with the main body at one of the first end and the second end; and
a tracking element encapsulated inside of the cavity and is free from being in contact with an external environment that is external to the main body;
wherein the main body is adapted to be mounted to a shipping unit.

12. The tracking apparatus of claim 11, wherein the main body further comprises:
a base wall positioned between the first end and the second end; and
an internal lateral wall extending outwardly from the base wall and positioned between the first end and the second end;
wherein the base wall and the internal lateral wall collectively define the cavity.

13. The tracking apparatus of claim 12, wherein the main body further comprises:
a top end;
a bottom end opposite to the top end; and
a protrusion extending outwardly from the top end, wherein the protrusion is in communication with the internal lateral wall and the base wall.

14. The tracking apparatus of claim 13, wherein the cavity is accessible from the bottom end only.

15. The tracking apparatus of claim 11, further comprising:
a first opening defined in the main body at the first end; and
a second opening defined in the main body at the second end opposite to the first opening;
wherein the cavity is defined between the first opening and the second opening and is free from being in communication with the first opening and the second opening.

16. The tracking apparatus of claim 15, further comprising:
a pair of fasteners operably engageable with the main body at the first opening and the second opening;
wherein the first opening and the second opening are configured to receive the pair of fasteners for mounting said main body to the shipping unit.

17. A method of tracking a shipping unit with a tracking apparatus, comprising:
providing a tracking element of the tracking apparatus;
positioning the tracking element inside of a cavity defined in a main body of the tracking apparatus;
engaging at least one fastener of the tracking apparatus with the main body;
pressing the at least one fastener of the main body into the shipping unit until the tracking element is prevented from escaping the cavity; and
tracking the shipping unit with the tracking apparatus.

18. The method of claim 17, further comprising:
inserting the tracking element into the cavity at a bottom end of the main body; and
reading the tracking element at a top end of the main body.

19. The method of claim 17, wherein the step of engaging the at least one fastener with the main body further comprises:
inserting the at least one fastener through at least one opening defined in the main body; and
wherein the at least one opening and the cavity are free from being in communication with one another.

20. The method of claim 17, wherein the step of engaging the at least one fastener with the main body further comprises:
inserting a pair of fasteners through a pair of openings defined in the main body;
wherein the pair of openings and the cavity are free from being in communication with one another.
